(19) United States
(12) Patent Application Publication
(10) Pub. No.: US 2016/0274353 A1
(43) Pub. Date: Sep. 22, 2016

(54) FLUORESCENT WHEEL FOR PROJECTORS AND LIGHT-EMITTING DEVICE FOR PROJECTORS

(71) Applicant: NIPPON ELECTRIC GLASS CO., LTD., Otsu-shi, Shiga (JP)

(72) Inventors: Tamio ANDO, Otsu-shi (JP); Tadahito FURUYAMA, Otsu-shi (JP); Shunsuke FUJITA, Otsu-shi (JP)

(21) Appl. No.: 15/030,124

(22) PCT Filed: Oct. 28, 2014
(86) PCT No.: PCT/JP2014/078566

§ 371 Date: Apr. 18, 2016

(30) Foreign Application Priority Data
Nov. 13, 2013 (JP) 2013-234799

(51) Int. Cl. G02B 26/00; G03B 21/20; C03C 4/12; C09K 11/02; C03C 3/00

(52) U.S. Cl. CPC G02B 26/008; C09K 11/02; C03C 3/00; C03C 4/12; G03B 21/204; C03C 2204/00

(57) ABSTRACT

Provided is a fluorescent wheel for a projector capable of increasing the luminescence intensity and a light-emitting device for a projector using the same. The fluorescent wheel for a projector includes: an annular transparent substrate (11) including a first principal surface (11a) located on a side where excitation light (1) enters and a second principal surface (11b) located on a side where the excitation light (1) exits; a phosphor layer (12) provided on the second principal surface (11b) of the transparent substrate (11) and including an inorganic binder and a phosphor dispersed in the inorganic binder; and a filter layer (13) provided on the first principal surface (11a) of the transparent substrate (11) or between the second principal surface (11b) of the transparent substrate (11) and the phosphor layer (12) and configured to transmit the excitation light (1) and reflect fluorescence (2) emitted from the phosphor layer (12).

### TECHNICAL FIELD

This invention relates to fluorescent wheels for projectors and light-emitting devices for projectors.

### BACKGROUND ART

To reduce projector size, there have recently been proposed light-emitting devices in which an LED (light emitting diode) and a phosphor are used. For example, Patent Literature 1 discloses a projector in which use is made of a light-emitting device including: a light source configured to emit ultraviolet light; and a phosphor layer configured to convert the ultraviolet light from the light source into visible light. In Patent Literature 1, a fluorescent wheel is used which is produced by providing an annular phosphor layer on an annular rotatable transparent substrate.

### CITATION LIST

### Patent Literature

### [PTL 1]

### JP-A-2004-341105

### SUMMARY OF INVENTION

### Technical Problem

Light-emitting devices in which conventional fluorescent wheels are used have the problem that their luminescence intensity is insufficient.

An object of the present invention is to provide a fluorescent wheel for a projector capable of increasing the luminescence intensity and a light-emitting device for a projector using the same.

### Solution to Problem

A fluorescent wheel for a projector according to the present invention includes: an annular transparent substrate including a first principal surface located on a side where excitation light enters and a second principal surface located on a side where the excitation light exits; a phosphor layer provided on the second principal surface of the transparent substrate and including an inorganic binder and a phosphor dispersed in the inorganic binder; and a filter layer provided on the first principal surface of the transparent substrate or between the second principal surface of the transparent substrate and the phosphor layer and configured to transmit the excitation light and reflect fluorescence emitted from the phosphor layer.

The phosphor layer is preferably provided in an annular shape.

The transparent substrate preferably has a thickness of 2.0 mm or less.

The phosphor layer preferably has, in a circumferential direction, a width equal to or more than six times a spot diameter of the excitation light.

The excitation light is, for example, blue light. Furthermore, the fluorescence is, for example, green light, yellow light or red light.

The filter layer is preferably a bandpass filter capable of transmitting 95% or more of light in a wavelength range of 410 to 450 nm and reflecting 95% or more of light in a wavelength range of 500 to 750 nm.

The inorganic binder is, for example, glass.

The difference in refractive index between the transparent substrate and the inorganic binder is preferably 0.4 or less.

The phosphor layer may be divided into a plurality of regions along a circumferential direction thereof and the plurality of regions may contain different types of phosphors.

A light-emitting device for a projector according to the present invention includes the above-described fluorescent wheel for a projector according to the present invention and a light source capable of irradiating the phosphor layer of the fluorescent wheel with the excitation light.

### Advantageous Effects of Invention

The present invention can increase the luminescence intensity of the light-emitting device for a projector.

### BRIEF DESCRIPTION OF DRAWINGS

FIG. 1 is a perspective view showing a fluorescent wheel for a projector according to a first embodiment of the present invention.

FIG. 2 is a cross-sectional view along the line A-A shown in FIG. 1.

FIG. 3 is a partial plan view showing on an enlarged scale a phosphor layer in the fluorescent wheel for a projector according to the first embodiment of the present invention.

FIG. 4 is a schematic cross-sectional view showing a reflected state of fluorescence in the fluorescent wheel for a projector according to the first embodiment of the present invention.

FIG. 5 is a schematic side view showing a light-emitting device in which the fluorescent wheel for a projector according to the first embodiment of the present invention is used.

FIG. 6 is a graph showing a spectral property of a filter layer in the fluorescent wheel for a projector according to the first embodiment of the present invention.

FIG. 7 is a graph showing luminescence intensity when a green phosphor was used in the first embodiment of the present invention.

FIG. 8 is a graph showing luminescence intensity when a yellow phosphor was used in the first embodiment of the present invention.

FIG. 9 is a cross-sectional view showing a fluorescent wheel for a projector according to a second embodiment of the present invention and corresponding to FIG. 2 in the first embodiment.

FIG. 10 is a schematic cross-sectional view showing a reflected state of fluorescence in the fluorescent wheel for a projector according to the second embodiment of the present invention.

FIG. 11 is a graph showing luminescence intensities when green phosphors were used in the first and second embodiments of the present invention.

FIG. 12 is a perspective view showing a fluorescent wheel for a projector according to a third embodiment of the present invention.

### DESCRIPTION OF EMBODIMENTS

Hereinafter, a description will be given of preferred embodiments. However, the following embodiments are simply illustrative and the present invention is not intended to be limited to the following embodiments. In the drawings, elements having substantially the same functions may be referred to by the common references.

### First Embodiment

In a first embodiment, a filter layer is provided on a first principal surface of a transparent substrate.

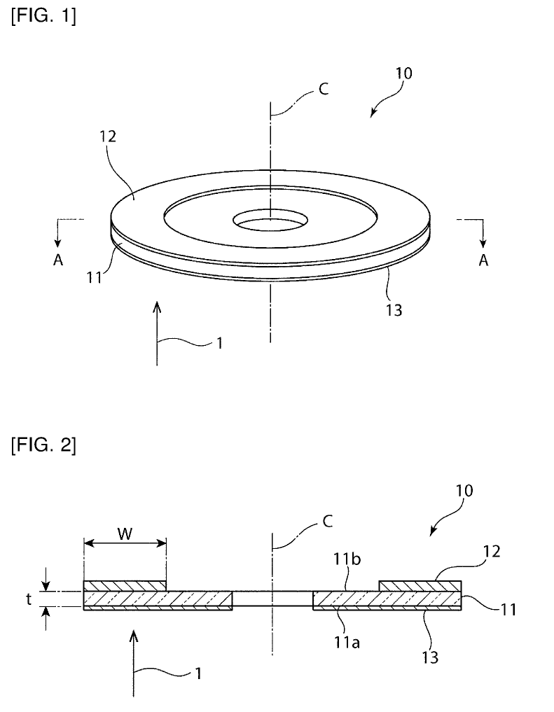

FIG. 1 is a perspective view showing a fluorescent wheel for a projector according to the first embodiment of the present invention. FIG. 2 is a cross-sectional view along the line A-A shown in FIG. 1. As shown in FIGS. 1 and 2, a fluorescent wheel 10 has an annular shape. The fluorescent wheel 10 includes: an annular transparent substrate 11; an annular phosphor layer 12 provided on a second principal surface 11b of the transparent substrate 11; and a filter layer 13 provided on a first principal surface 11a of the transparent substrate 11. The first principal surface 11a of the transparent substrate 11 is a principal surface located on the side where excitation light 1 enters. The second principal surface 11b of the transparent substrate 11 is a principal surface located on the side where the excitation light 1 exits.

In this embodiment, the phosphor layer 12 is composed of an inorganic binder and a phosphor dispersed in the inorganic binder. In this embodiment, an inorganic phosphor is used as the phosphor.

No particular limitation is placed on the type of the inorganic binder so long as it can be used as a dispersion medium for the phosphor, such as an inorganic phosphor. Examples that can be cited include glasses, such as borosilicate-based glasses and phosphate-based glasses. Note that the softening point of the glass is preferably 250° C. to 1000° C. and more preferably 300° C. to 850° C.

Alternatively, a transparent inorganic material for use in a sol-gel method can be used as the inorganic binder. An example of such a transparent inorganic material that can be cited is polysilazane. Polysilazane is capable of reacting on moisture in the air to generate ammonia and become condensed to form a SiO2 network. With the use of the transparent inorganic material, the phosphor layer 12 can be formed at relatively low temperatures (room temperature to 200° C.). Other transparent inorganic materials that can be cited include those which contain an alcohol-soluble organic silicon compound or other metal compounds (organic or inorganic) and form a SiO2 network, like glass, at relatively low temperatures in the presence of a catalyst. When such a transparent inorganic material is used together with a metal alkoxide as an organometallic compound and an alcohol as a catalyst, hydrolysis and dehydration are promoted, resulting in the formation of a SiO₂ network.

No particular limitation is placed on the type of the phosphor so long as it can emit fluorescence upon entry of the excitation light 1. Specific examples of the phosphor that can be cited include one or more selected from the group consisting of, for example, oxide phosphor, nitride phosphor, oxynitride phosphor, chloride phosphor, oxychloride phosphor, sulfide phosphor, oxysulfide phosphor, halide phosphor, chalcogenide phosphor, aluminate phosphor, halophosphoric acid chloride phosphor, and garnet-based compound phosphor. With the use of blue light as excitation light, a phosphor capable of emitting as fluorescence, for example, green light, yellow light or red light can be used.

The content of the phosphor in the phosphor layer 12 is preferably in a range of 5 to 80% by volume, more preferably in a range of 10 to 75% by volume, and still more preferably in a range of 20 to 70% by volume.

The thickness of the phosphor layer 12 is preferably small to the extent that the excitation light 1 can be surely absorbed into the phosphor. The reason for this is that if the phosphor layer 12 is too thick, scattering and absorption of light in the phosphor layer 12 may become too much, so that the efficiency of emission of fluorescence may be low. Specifically, the thickness of the phosphor layer 12 is preferably 1 mm or less, more preferably 0.5 mm or less, and still more preferably 0.3 mm or less. The lower limit of the thickness of the phosphor layer 12 is generally about 0.03 mm.

The filter layer 13 is a filter layer configured to transmit the excitation light 1 and reflect the fluorescence emitted from the phosphor layer 12. In this embodiment, the filter layer 13 is a bandpass filter formed of a dielectric laminated film. The dielectric laminated film herein is a so-called dielectric multi-layer and is formed of a laminate of high-refractive index films and low-refractive index films. An example of the dielectric laminated film that can be used as the bandpass filter is a film in which high-refractive index films made of niobium oxide, titanium oxide, lanthanum oxide, tantalum oxide, yttrium oxide, gadolinium oxide, tungsten oxide, hafnium oxide, aluminum oxide, silicon nitride or other materials and low-refractive index films made of silicon oxide or other materials are alternately deposited.

With the use of blue light as the excitation light, an example of the filter layer 13 that can be used is a bandpass filter capable of transmitting 95% or more of light in a wavelength range of 410 to 450 nm and reflecting 95% or more of light in a wavelength range of 500 to 750 nm.

The geometric thickness of the filter layer 13 is appropriately adjusted within a range of 80 to 10000 nm according to the desired property. If the geometric thickness of the filter layer 13 is too small, the function of selectively transmitting desired visible light is less likely to be obtained. On the other hand, if the geometric thickness of the filter layer 13 is too large, the stress generating in the filter layer 13 becomes large, so that cracks may occur or the filter layer 13 may be peeled from the substrate.

When the filter layer 13 is formed of a multi-layer in which high-refractive index films and low-refractive index films are alternately deposited, the number of films deposited is appropriately adjusted within a range of 8 to 100.

No particular limitation is placed on the type of the transparent substrate 11 so long as it can transmit excitation light applied from a light source. Therefore, the term “transparent” of the transparent substrate 11 means being transparent to excitation light. Examples of the transparent substrate 11 that can be used include inorganic substrates, such as a glass substrate, a crystallized glass substrate and a ceramic substrate, and resin substrates. With the use of an inorganic substrate as the transparent substrate 11, the phosphor layer 12 can be formed directly on top of (inorganically bonded to) the transparent substrate 11 by applying an inorganic binder containing a phosphor on the surface of the transparent substrate 11 and subjecting them to heat treatment. The fluorescent wheel 10 thus produced is composed only of inorganic materials and, therefore, has excellent thermal resistance. Other than the above, examples of a method for forming the phosphor layer 12 on top of the transparent substrate 11 include the method of spraying an inorganic binder in slurry form containing a phosphor on the surface of the transparent substrate 11 and the method of screen-printing the inorganic binder in slurry form on the surface of the transparent substrate 11. The phosphor layer 12 and the transparent substrate 11 may be bonded together with a heat-resistant resin or glass.

In this embodiment, the thickness t of the transparent substrate 11 shown in FIG. 2 is preferably 2.0 mm or less. The thickness t of the transparent substrate 11 is more preferably 1.0 mm or less, still more preferably 0.6 mm or less, and even more preferably 0.4 mm or less. By making the thickness t of the transparent substrate 11 smaller, the rate at which light emitted from the phosphor layer 12 leaks to the outside can be reduced to increase the luminescence intensity. However, if the thickness t of the transparent substrate 11 is too small, the mechanical strength of the fluorescent wheel 10 is decreased, which makes it difficult to handle the fluorescent wheel 11 in practice. Therefore, the thickness t of the transparent substrate 11 is preferably not less than 0.1 mm and more preferably not less than 0.2 mm.

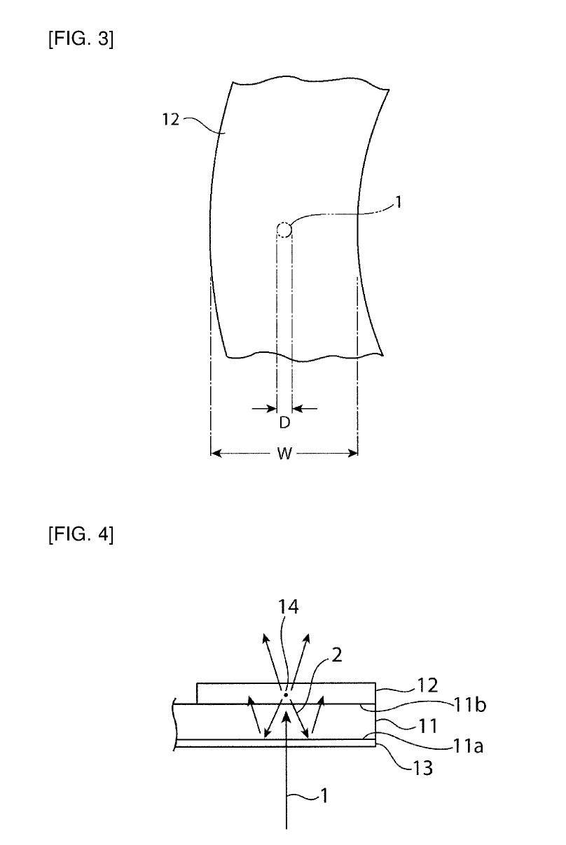

FIG. 3 is a partial plan view showing on an enlarged scale the phosphor layer in the fluorescent wheel for a projector according to the first embodiment of the present invention. In this embodiment, the width W of the phosphor layer 12 is equal to or more than six times the spot diameter D of the excitation light 1. By making the width W of the phosphor layer 12 equal to or more than six times the spot diameter D of the excitation light 1, the fluorescence or the excitation light 1 can be repeatedly scattered or reflected over a wide region in the phosphor layer 12. Therefore, the luminescence efficiency can be increased to increase the luminescence intensity of fluorescence emitted from the phosphor layer 12. The width W of the phosphor layer 12 is preferably equal to or more than seven times the spot diameter D of the excitation light 1, more preferably equal to or more than ten times the spot diameter D of the excitation light 1, and particularly preferably equal to or more than thirteen times the spot diameter D of the excitation light 1. The width W of the phosphor layer 12 is preferably not more than twenty times the spot diameter D of the excitation light 1. If the width W of the phosphor layer 12 is too large, the fluorescent wheel 10 becomes large in size, which is undesirable. In addition, this is undesirable because much phosphor is needed.

FIG. 4 is a schematic cross-sectional view showing a reflected state of fluorescence in the fluorescent wheel for a projector according to the first embodiment of the present invention. As shown in FIG. 4, the excitation light 1 penetrates the filter layer 13 and enters through the first principal surface 11a of the transparent substrate 11 into the phosphor layer 12. The excitation light 1 having entered the phosphor layer 12 excites the phosphor 14 in the phosphor layer 12, so that fluorescence 2 is emitted from the phosphor 14. Part of the fluorescence 2 emitted from the phosphor 14 travels toward the transparent substrate 11, is then reflected, as shown in FIG. 4, on the filter layer 13, and enters the phosphor layer 12 again. Therefore, in the present invention, the amount of fluorescence 2 emitted from the phosphor layer 12 can be increased to enhance the luminescence intensity.

If the difference in refractive index between the transparent substrate 11 and the phosphor layer 12 is made small, it can be suppressed that while the excitation light 1 having permeated the transparent substrate 11 enters the phosphor layer 12, it is reflected at the interface between the transparent substrate 11 and the phosphor layer 12. Therefore, the amount of excitation light 1 entering the phosphor layer 12 can be increased. An example of a method for making the difference in refractive index between the transparent substrate 11 and the phosphor layer 12 small when a glass substrate is used as the transparent substrate 11 is the method of making the difference in refractive index between glass for use in the glass substrate and an inorganic binder in the phosphor layer 12 small. The difference in refractive index between the transparent substrate 11 and the inorganic binder in the phosphor layer 12 is preferably 0.4 or less.

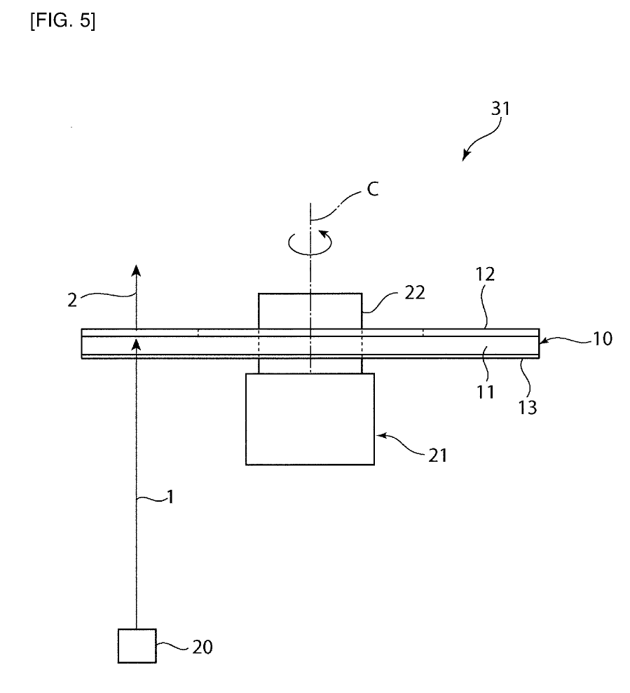

FIG. 5 is a schematic side view showing a light-emitting device in which the fluorescent wheel for a projector according to the first embodiment of the present invention is used. A light-emitting device 31 for a projector according to this embodiment includes the fluorescent wheel 10, a light source 20, and a motor 21 for rotating the fluorescent wheel 10. The annular fluorescent wheel 10 is attached to a rotary shaft 22 of the motor 21 rotatably in the circumferential direction with the central axis C of the rotary shaft 22 as the center of rotation.

Excitation light 1 emitted from the light source 20 passes through the filter layer 13 and the transparent substrate 11 of the fluorescent wheel 10 and then enters the phosphor layer 12. The excitation light 1 having entered the phosphor layer 12 excites the phosphor, so that fluorescence 2 is emitted from the phosphor. Specific examples of the light source 20 that can be cited include an LED light source and a laser light source.

In the case of using as the light source 20 a light source emitting blue light as excitation light, for example, a phosphor capable of being excited by blue light to emit yellow light, green light or red light can be used as the phosphor for the phosphor layer 12. It is possible to extract, from the light emitted from the phosphor layer 12, only part thereof having a desired wavelength using a filter as necessary. An annular filter may be attached to the rotary shaft 22 and rotated in synchronism with the fluorescent wheel 10 to filter the emitted light.

In this embodiment, the fluorescent wheel 10 is configured to rotate circumferentially. Therefore, the region being subjected to the excitation light 1 from the light source 20 keeps moving, so that even if it is subjected to the excitation light 1 and heated, the heat is immediately released. Thus, the temperature rise of the fluorescent wheel 10 can be suppressed.

### Measurement of Luminescence Intensity

Using glass substrates having a thickness of 0.55 mm as transparent substrates 11, a fluorescent wheel 10 provided with a filter layer 13 on the incident surface (first principal surface 11a) of the transparent substrate 11 and a fluorescent wheel not provided with any filter layer 13 were produced.

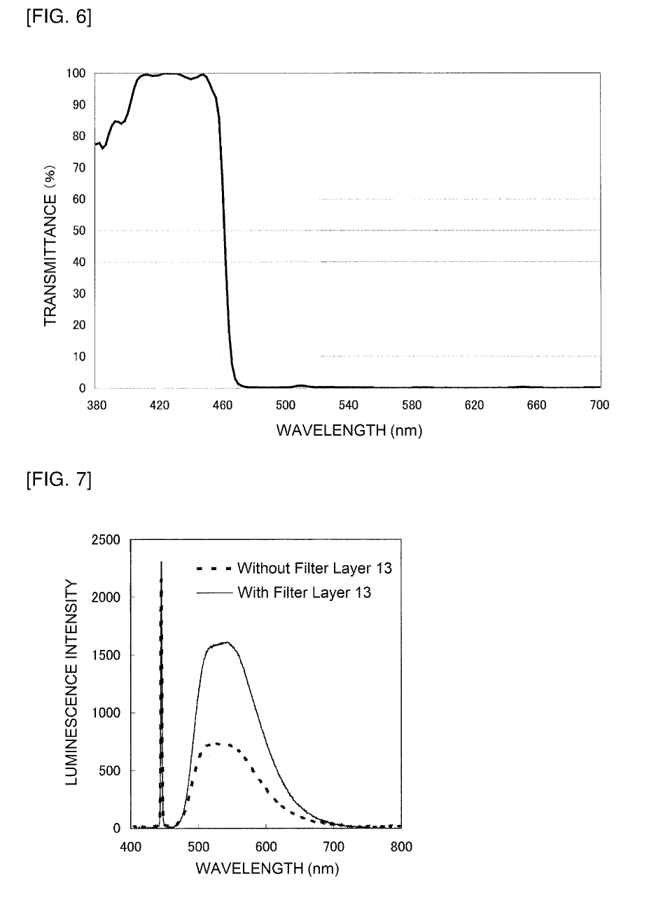

FIG. 6 is a graph showing a spectral property of the filter layer 13. The abscissa represents the wavelength (nm) and the ordinate represents the transmittance (%).

As phosphor layers 12, two types of phosphor layers were formed: a phosphor layer in which a phosphor capable of being excited by blue light to emit green light as fluorescence was used; and a phosphor layer in which a phosphor capable of being excited by blue light to emit yellow light as fluorescence was used. Therefore, a total of four types of fluorescent wheels were produced.

Light having a wavelength of 445 nm was applied as excitation light 1 and the intensity of fluorescence emitted from the phosphor layer 12 was measured with an integrating sphere having a 13 mm diameter opening, disposed above the phosphor layer 12.

FIG. 7 is a graph showing luminescence intensities when the green-emitting phosphors were used. As shown in FIG. 7, the provision of the filter layer 13 significantly increased the luminescence intensity. By the provision of the filter layer 13, the peak intensity of fluorescence near a wavelength of 540 nm reached 2.3 times that when no filter layer 13 was provided.

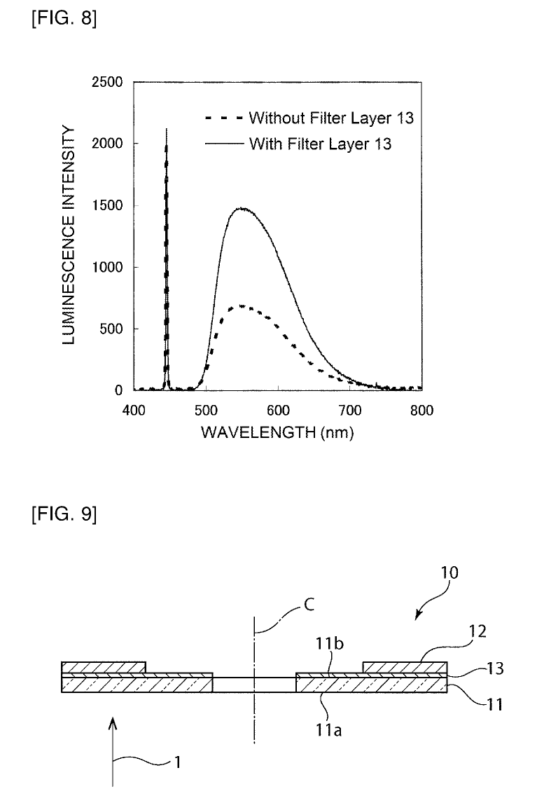

FIG. 8 is a graph showing luminescence intensities when the yellow-emitting phosphors were used. As shown in FIG. 8, the provision of the filter layer 13 significantly increased the luminescence intensity. By the provision of the filter layer 13, the peak intensity of fluorescence near a wavelength of 545 nm reached 2.2 times that when no filter layer 13 was provided.

### Second Embodiment

In a second embodiment, a filter layer is provided between a second principal surface of a transparent substrate and a phosphor layer.

FIG. 9 is a cross-sectional view showing a fluorescent wheel for a projector according to the second embodiment of the present invention and corresponding to FIG. 2 in the first embodiment. As shown in FIG. 9, a fluorescent wheel 10 has an annular shape. The fluorescent wheel 10 includes: an annular transparent substrate 11; an annular phosphor layer 12 provided above a second principal surface 11b of the transparent substrate 11; and a filter layer 13 provided between the second principal surface 11b of the transparent substrate 11 and the phosphor layer 12. Like the first embodiment, a first principal surface 11a of the transparent substrate 11 is a principal surface located on the side where excitation light 1 enters, while the second principal surface 11b of the transparent substrate 11 is a principal surface located on the side where the excitation light 1 exits.

Examples of the transparent substrate 11, the phosphor layer 12, and the filter layer 13 that can be used in this embodiment are the same as those in the first embodiment.

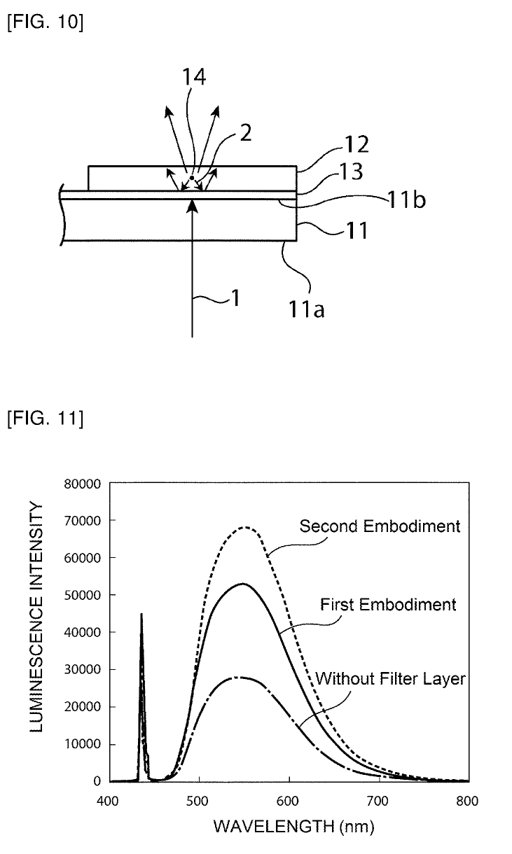

FIG. 10 is a schematic cross-sectional view showing a reflected state of fluorescence in the fluorescent wheel for a projector according to the second embodiment of the present invention. As shown in FIG. 10, the excitation light 1 passes through the first principal surface 11a of the transparent substrate 11, then penetrates the filter layer 13, and enters the phosphor layer 12. The excitation light 1 having entered the phosphor layer 12 excites the phosphor 14 in the phosphor layer 12, so that fluorescence 2 is emitted from the phosphor 14. Part of the fluorescence 2 emitted from the phosphor 14 travels toward the transparent substrate 11, is reflected, as shown in FIG. 10, on the filter layer 13, and enters the phosphor layer 12 again. Therefore, in this embodiment, the amount of fluorescence 2 emitted from the phosphor layer 12 can be increased to enhance the luminescence intensity.

Furthermore, in this embodiment, since the filter layer 13 is provided between the transparent substrate 11 and the phosphor layer 12, it can be suppressed that the fluorescence 2 emitted from the phosphor layer 12 enters the transparent substrate 11. In the first embodiment, as shown in FIG. 4, the fluorescence 2 emitted from the phosphor layer 12 enters the transparent substrate 11. Therefore, the fluorescence 2 may be reflected inside the transparent substrate 11 and then leak from the side surface of the transparent substrate 11. Since in this embodiment it can be suppressed that the fluorescence 2 emitted from the phosphor layer 12 enters the transparent substrate 11, it can also be suppressed that the fluorescence 2 leaks from the side surface of the transparent substrate 11. Therefore, in this embodiment, the luminescence intensity can be further increased.

The fluorescent wheel according to this embodiment can also be used for the light-emitting device shown in FIG. 5.

### Measurement of Luminescence Intensity

Using glass substrates having a thickness of 0.55 mm as transparent substrates 11, the following fluorescent wheels were produced:

a fluorescent wheel according to the first embodiment in which a filter layer 13 was provided on the incident surface (first principal surface 11a) of a transparent substrate 11;

a fluorescent wheel according to the second embodiment in which a filter layer 13 was provided between a transparent substrate 11 and a phosphor layer 12; and

a fluorescent wheel for comparison in which no filter layer 13 was provided.

The filter layers 13 used were those having a spectral property shown in FIG. 6. The phosphor layers 12 produced were those in which a phosphor capable of being excited by blue light to emit yellow light as fluorescence was used.

Light having a wavelength of 436 nm was applied and light emitted from each fluorescent wheel was focused on a photoreceiver using a lens and measured.

FIG. 11 is a graph showing respective luminescence intensities of the above fluorescent wheels. As shown in FIG. 11, the fluorescent wheels according to the first and second embodiments were significantly increased in luminescence intensity as compared to the fluorescent wheel for comparison in which no filter layer 13 was provided. In addition, it can be seen that as compared to the first embodiment, the fluorescent wheel according to the second embodiment exhibited a higher luminescence intensity.

In the fluorescent wheels 10 according to the above embodiments, a phosphor of the same type is contained in the whole area of the phosphor layer 12. However, the present invention is not limited to this form. As in an embodiment to be described below, the phosphor layer 12 may be divided into a plurality of regions along the circumferential direction thereof and the plurality of regions may contain different types of phosphors.

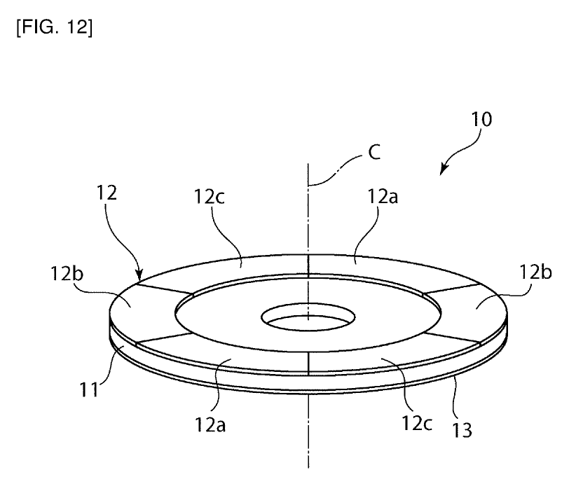

FIG. 12 is a perspective view showing a fluorescent wheel for a projector according to a third embodiment of the present invention. In this embodiment, a filter layer 13 is provided on a first principal surface 11a of a transparent substrate 11 in accordance with the first embodiment. The fluorescent wheel 10 shown in FIG. 12 has a pair of first regions 12a, a pair of second regions 12b, and a pair of third regions 12c. These regions are provided as circumferential sections as shown in FIG. 12. These regions can be provided to correspond to regions emitting, for example, red light, green light or blue light as fluorescence, so that the fluorescent wheel 10 can be used as a color wheel.

Although in the embodiment shown in FIG. 12 the filter layer 13 is provided on the first principal surface 11a of the transparent substrate 11, it is possible that a filter 13 is provided between the transparent substrate 11 and the phosphor layer 12 in accordance with the second embodiment and the phosphor layer 12 is divided into a plurality of regions along the circumferential direction.

Also when the phosphor layer 12 is divided into a plurality of regions along the circumferential direction, the luminescence intensity of fluorescence emitted from each of the first regions 12a, the second regions 12b, and the third regions 12c can be increased by providing the filter layer 13 on the first principal surface 11a of the transparent substrate 11 or between the second principal surface 11a thereof and the phosphor layer 12. Alternatively, any one of the first region 12a, the second region 12b, and the third region 12c may be a region not provided with the phosphor layer 12.

### Reference Signs List

1 . . . excitation light

2 . . . fluorescence

10 . . . fluorescent wheel

11 . . . transparent substrate

11a . . . first principal surface

11b . . . second principal surface

12 . . . phosphor layer

12a to 12c . . . first to third regions

13 . . . filter layer

14 . . . phosphor

20 . . . light source

21 . . . motor

22 . . . rotary shaft

31 . . . light-emitting device for projector

1. A fluorescent wheel for a projector comprising:
an annular transparent substrate including a first principal surface located on a side where excitation light enters and a second principal surface located on a side where the excitation light exits;
a phosphor layer provided on the second principal surface of the transparent substrate and including an inorganic binder and a phosphor dispersed in the inorganic binder; and
a filter layer provided on the first principal surface of the transparent substrate or between the second principal surface of the transparent substrate and the phosphor layer and configured to transmit the excitation light and reflect fluorescence emitted from the phosphor layer.

2. The fluorescent wheel for a projector according to claim 1, wherein the phosphor layer is provided in an annular shape.

3. The fluorescent wheel for a projector according to claim 1, wherein the transparent substrate has a thickness of 2.0 mm or less.

4. The fluorescent wheel for a projector according to claim 1, wherein the phosphor layer has, in a circumferential direction, a width equal to or more than six times a spot diameter of the excitation light.

5. The fluorescent wheel for a projector according to claim 1, wherein the excitation light is blue light.

6. The fluorescent wheel for a projector according to claim 1, wherein the fluorescence is green light, yellow light or red light.

7. The fluorescent wheel for a projector according to claim 5, wherein the filter layer is a bandpass filter capable of transmitting 95% or more of light in a wavelength range of 410 to 450 nm and reflecting 95% or more of light in a wavelength range of 500 to 750 nm.

8. The fluorescent wheel for a projector according to claim 1, wherein the inorganic binder is glass.

9. The fluorescent wheel for a projector according to claim 1, wherein a difference in refractive index between the transparent substrate and the inorganic binder is 0.4 or less.

10. The fluorescent wheel for a projector according to claim 1, wherein the phosphor layer is divided into a plurality of regions along a circumferential direction thereof and the plurality of regions contain different types of phosphors.

11. A light-emitting device for a projector comprising:
the fluorescent wheel for a projector according to claim 1; and
a light source capable of irradiating the phosphor layer of the fluorescent wheel with the excitation light.
